(19) United States
(12) Patent Application Publication
(10) Pub. No.: US 2012/0281289 A1
(43) Pub. Date: Nov. 8, 2012

(54) LIGHT-DIFFUSION SHEET, METHOD FOR MANUFACTURING SAME, AND TRANSMISSION DISPLAY DEVICE PROVIDED WITH THIS LIGHT-DIFFUSION SHEET

(75) Inventors: Akinori Itoh, Osaka-shi (JP); Tokiyoshi Umeda, Osaka-shi (JP)

(73) Assignee: SHARP KABUSHIKI KAISHA, Osaka-shi, Osaka (JP)

(21) Appl. No.: 13/519,136

(22) PCT Filed: Oct. 26, 2010
(86) PCT No.: PCT/JP2010/068963

§ 371 Date: Jun. 26, 2012

(30) Foreign Application Priority Data
Jan. 14, 2010 (JP) 2010-006162

(51) Int. Cl. G02B 5/02; B05D 5/06

(52) U.S. Cl. 359/599; 427/162

(57) ABSTRACT

A light-diffusion sheet (1) includes a light diffusing section (2) which is provided on a substrate (6) and has a plurality of recessed parts (5) each of which has a v-shaped cross section. A light blocking section (3) is provided in each of the plurality of recessed parts (5), and a reflecting section (4) made of mesoporous silica (8) is provided so as to close a gap between the light blocking section (3) and the each of the plurality of recessed parts (5). The mesoporous silica (8) causes the reflecting section (4) to have a low refractive index. This causes a difference in refractive index between the reflecting section (4) and the light diffusing section (2), so that entrance light having entered the light-diffusion sheet (1) can be totally reflected with great efficiency. Further, since it is unnecessary to use an expensive high refractive index material for the light diffusing section (2), the light-diffusion sheet (1) can be manufactured at a reduced manufacturing cost.

### TECHNICAL FIELD

The present invention relates to a light-diffusion sheet which is suitably used for a display device such as a liquid crystal display device, a method for manufacturing the light-diffusion sheet, and a transmission display device including the light-diffusion sheet.

### BACKGROUND ART

Research and development of display devices has been remarkable in recent years. Thin flat-panel display (FPD) display devices have been extensively used instead of conventionally mainstream cathode-ray-tube display devices. Such FPD display devices include a display device which uses a light-emitting diode (LED) or an organic electroluminescence (EL) as a display element.

Each of these display devices emits light toward a display screen or causes a backlight or the like provided on a back side of the display screen (on a side which is opposite from an observer) to emit light. The observer visually recognizes the light having exited from the display screen. Note that a display device is designed so that light which obliquely exits from a display screen and light which exits to the front of the display screen are similarly seen. Namely, the display device is designed so that the display screen which is obliquely seen and the display screen which is seen from the front are similar. However, such designing is insufficient. Though the display device has an excellent contrast characteristic when seen from the front, the display device may have more sense of change when obliquely seen than when seen from the front. Accordingly, the display device has a problem such that how a display is seen differs depending on in which direction the display device is observed, i.e., a deterioration in viewing angle characteristic occurs in the display device.

In view of the circumstances, as a method for improving the viewing angle characteristic of the display device, a method has been developed which allows the display device to be obliquely observed by providing, on the observer's side of the display device, a sheet for diffusing light. The sheet for diffusing light is exemplified by a light-diffusion sheet whose top surface has been subjected to an unevenness treatment and a light-diffusion sheet which contains a light diffusing fine particle. The light-diffusion sheet multidirectionally refracts (totally reflects) light from the backlight by use of a difference in refractive index. The light refracted by the light-diffusion sheet is multidirectionally diffused and exits through the top surface of the light-diffusion sheet toward the observer. As described above, use of the light-diffusion sheet allows the display device to be visible from every direction by diffusion of light from the display device. As a result, a display device can be made in which an image obtained when the display device is seen from the front and an image obtained when the display device is obliquely seen are identical and which has no sense of change in viewing angle.

However, such a light diffusion characteristic of the light-diffusion sheet causes irregular reflection of image light or external light, so that many stray lights occur. This causes, for example, a decrease in surface luminance and contrast of the display device. Further, there is a limit to light which the light-diffusion sheet can totally reflect. Light which enters the light-diffusion sheet (display screen) at a small angle is not totally reflected. This causes a degree with which image light is diffused (an efficiency for light utilization) to be low, so that a visibility of the display device is reduced.

In view of the circumstances, various methods for improving a characteristic of the light-diffusion sheet have been devised. For example, Patent Literature 1 discloses the light-diffusion sheet which has a light blocking section. Specifically, the light-diffusion sheet disclosed in Patent Literature 1 is constituted by a light diffusing section and the light blocking section. A plurality of grooves each of which has a v-shaped cross section are juxtaposed to each other on the observation surface side of the light diffusing section. The light blocking section is provided on the observation surface side of each of the plurality of grooves, and the remaining space of the each of the plurality of grooves is filled with air. According to this, most of a stray light which passes through the light-diffusion sheet is absorbed in a light absorbing layer. This can prevent, for example, a decrease in contrast.

According to the light-diffusion sheet which is disclosed in Patent Literature 1 and has the light blocking section, the light blocking section is commonly made of a resin which contains a particle colored with a pigment such as carbon. The light-diffusion sheet disclosed in Patent Literature 1 is arranged such that the light blocking section has a lower refractive index than the light diffusing section. According to this, a stray light having entered the light blocking section can be absorbed while light other than the stray light can be totally reflected in an interface between the light diffusing section and the light blocking section.

Accordingly, in order to totally reflect light in the interface between the light diffusing section and the light blocking section, it is desirable to increase a difference in refractive index between the light diffusing section and the light blocking section as much as possible. In order to increase the difference, it is desirable to cause the light blocking section to have a low refractive index. However, in order for the light blocking section to maintain the low refractive index, it is impossible to cause the light blocking section to contain the pigment in a higher concentration. This causes the light blocking section to have a low optical density (OD value). Therefore, there occurs a problem such that a stray light having entered the light blocking section passes through the light blocking section. This causes a decrease in front contrast, a blur in an image, or the like.

In contrast, it is considered that a stray light can be prevented from passing through the light blocking section by causing the light diffusing section to have a high refractive index instead of causing the light blocking section to have a low refractive index. However, use of a high refractive index material for the light diffusing section increases a material cost and consequently increases a manufacturing cost. This makes it difficult to widely use the light-diffusion sheet which uses the high refractive index material for the light diffusing section.

In view of the circumstances, a new method for further improving a characteristic of the light-diffusion sheet has been devised. For example, Patent Literature 2 discloses the light-diffusion sheet which has a light blocking section whose periphery is coated with a low refractive index resin. Specifically, the light-diffusion sheet disclosed in Patent Literature 2 is constituted by a light diffusing section and the light blocking section. A plurality of grooves each of which has a v-shaped cross section are juxtaposed to each other on the observation surface side of the light diffusing section. The light blocking section is provided in each of the plurality of grooves, and a low refractive index resin is provided between the light blocking section and a wall surface of the each of the plurality of grooves. A fine particle (an amorphous silica particle) is mixed with the low refractive index resin. According to this, light having entered a groove of the light diffusing section is totally reflected in an interface between the light diffusing section and the low refractive index resin. In contrast, a stray light having entered the groove of the light diffusing section is transmitted through the low refractive index resin and absorbed in the light blocking section. According to this, the stray light having entered the groove of the light diffusing section can be prevented from passing through the light diffusing section, and light having entered the groove can be totally reflected with great efficiency and diffused.

### CITATION LIST

### Patent Literatures

Patent Literature 1

Japanese Patent Application Publication, Tokukai, No. 2000-352608 A (Publication Date: Dec. 19, 2000)

Patent Literature 2

Japanese Patent Application Publication, Tokukai, No. 2009-63849 A (Publication Date: Mar. 26, 2009)

### SUMMARY OF INVENTION

### Technical Problem

As described earlier, according to the light-diffusion sheet disclosed in Patent Literature 2, the stray light having entered the groove of the light diffusing section can be prevented from passing through the light diffusing section, and the light having entered the groove can be totally reflected with great efficiency and diffused. However, according to the light-diffusion sheet disclosed in Patent Literature 2, a high refractive index resin is used for the light diffusing section, and a low refractive index resin is provided between the light diffusing section and the light blocking section. Accordingly, the use of a high refractive index resin and a low refractive index resin increases a material cost and consequently increases a manufacturing cost. This makes it difficult to widely use the light-diffusion sheet disclosed in Patent Literature 2. Further, in order to manufacture the light-diffusion sheet disclosed in Patent Literature 2, it is necessary to mix a fine particle with a low refractive index resin. This complicates an operation process.

Commonly, mixing of a porous particle with a resin causes the resin to have a low refractive index. However, an amorphous silica particle used in Patent Literature 2 as a fine particle has a large average particle size of 100 nm and a small surface area of 7 m²/g. Accordingly, even in a case where the amorphous silica particle is mixed with a low refractive index resin, the low refractive index resin cannot have a lower refractive index. Namely, only when a resin whose refractive index is as low as possible is used as a low refractive index resin, a difference in refractive index between the light diffusing section and the light blocking section increases, so that light having entered the light-diffusion sheet can be totally reflected with great efficiency. However, as described earlier, the use of a high refractive index resin and a low refractive index resin causes a problem of increasing a material cost and consequently increasing a manufacturing cost.

The present invention has been made in view of the problems, and an object of the present invention is to provide a light-diffusion sheet which is capable of totally reflecting light with great efficiency while reducing a manufacturing cost such as a material cost for the light-diffusion sheet, the light having entered the light-diffusion sheet, a method for manufacturing the light-diffusion sheet, and a transmission display device including the light-diffusion sheet.

### Solution to Problem

In order to attain the object, a light-diffusion sheet in accordance with the present invention includes: a light diffusing section which diffuses entrance light having entered the light-diffusion sheet through a light entrance surface thereof and causes the diffused entrance light to exit from the light-diffusion sheet through a light exit surface thereof; a supporting film which is provided on the light exit surface of the light diffusing section; a plurality of recessed parts which are provided in the light diffusing section on the light exit surface side and each of which has a wall surface that transmits or totally reflects the entrance light; a reflecting section which is provided in at least a part of the wall surface of each of the plurality of recessed parts and is made of a mesoporous silica nanoparticle, the reflecting section being provided for the each of the plurality of recessed parts; and a light blocking section which (i) is provided in a space defined by the reflecting section in a space defined by the wall surface and (ii) is supported by the supporting film, the light blocking section being provided for the each of the plurality of recessed parts.

According to the arrangement, a light diffusing section is provided on a supporting film, and the light diffusing section has a plurality of recessed parts. A reflecting section which is made of a mesoporous silica nanoparticle is provided in at least a part of a wall surface of each of the plurality of recessed parts. A light blocking section is provided in a space defined by the reflecting section in a space defined by the wall surface of the each of the plurality of recessed parts.

As described earlier, according to the light-diffusion sheet in accordance with the present invention, a reflecting section is made of a mesoporous silica nanoparticle. This causes the reflecting section to have a low refractive index. Therefore, a critical angle increases at which light that the light-diffusion sheet can totally reflect enters the light-diffusion sheet. As a result, the light-diffusion sheet can totally reflect a larger amount of light, so that an efficiency for light utilization can be enhanced.

The light blocking section, which is provided in the each of the plurality of recessed parts, absorbs light which is transmitted through the wall surface of the each of the plurality of recessed parts and enters the light blocking section. This can prevent occurrence of a stray light. Accordingly, the light-diffusion sheet in accordance with the present invention has the following separate functional parts: (i) the functional part which totally reflects light having entered the light-diffusion sheet and (ii) the functional part which absorbs a stray light having been transmitted through the wall surface of the each of the plurality of recessed parts. Namely, light having entered the light-diffusion sheet is totally reflected in an interface between the reflecting section and the light diffusing section. Therefore, according to the light-diffusion sheet, unlike a conventional light-diffusion sheet, it is unnecessary to use, for the light blocking section, a low refractive index material, and there is no problem with use of a material which has a high optical density (OD value). This can prevent a stray light having entered the light blocking section from passing through the light blocking section due to a low optical density of the light blocking section. Accordingly, a decrease in front contrast and a blur in an image can be substantially securely prevented.

According to a conventional light-diffusion sheet, in order to increase a difference in refractive index between the light blocking section and the light diffusing section, the light blocking section needs to have a low refractive index, whereas the light diffusing section needs to have a high refractive index. This imposes a constraint on a material of which a light-diffusion sheet is made, so that the light-diffusion sheet needs to be made of an uncommon special resin or the like. This increases a material cost and consequently increases a manufacturing cost. However, as described earlier, the reflecting section has a low refractive index. Therefore, according to the present invention, even if the light diffusing section is not made of a high refractive index material, a difference in refractive index from the reflecting section increases. Accordingly, the light diffusing section can be made of a widely-used material instead of an expensive material. This allows the light-diffusion sheet to be made at a reduced manufacturing cost.

In order to attain the object, a transmission display device in accordance with the present invention includes a light-diffusion sheet mentioned above.

According to the arrangement, a display device can be made which allows obtainment of a wide viewing angle, increases a front contrast, prevents occurrence of a blur in image, and has a high visibility.

In order to attain the object, a method in accordance with the present invention for manufacturing a light-diffusion sheet including a light diffusing section which diffuses entrance light having entered the light-diffusion sheet through a light entrance surface thereof and causes the diffused entrance light to exit from the light-diffusion sheet through a light exit surface thereof, the method includes the steps of: (a) forming a plurality of light blocking sections on a supporting film; (b) for each of the plurality of light blocking sections, forming a reflecting section by applying a mesoporous silica nanoparticle to at least a part of a top surface of the each of the plurality of light blocking sections; and (c) after the step (b), forming the light diffusing section so that the light diffusing section covers a top surface of the reflecting section, the light diffusing section being provided on a side of the supporting film on which side the plurality of light blocking sections are provided.

For a fuller understanding of the nature and advantages of the invention, reference should be made to the ensuing detailed description taken in conjunction with the accompanying drawings.

### Advantageous Effects of Invention

The light-diffusion sheet in accordance with the present invention is arranged such that the reflecting section is made of the mesoporous silica nanoparticle. This increases a difference in refractive index between the reflecting section and the light diffusing section, so that entrance light having entered the light-diffusion sheet can be totally reflected with great efficiency. Further, the reflecting section, which can have a low refractive index, causes an increase in difference in refractive index between the light diffusing section and the reflecting section even if the light diffusing section is not made of a high refractive index material. Accordingly, the light diffusing section can be made of a widely-used material instead of an expensive material. This allows the light-diffusion sheet to be made at a reduced manufacturing cost.

### BRIEF DESCRIPTION OF DRAWINGS

FIG. 1 illustrates a cross section of a light-diffusion sheet in accordance with an embodiment of the present invention.

FIG. 2 illustrates a principle of the light-diffusion sheet in accordance with the embodiment of the present invention.

FIG. 3 shows a relationship between a concentration of mesoporous silica contained in a resin and a refractive index of the resin.

FIG. 4 is an arrangement example of recessed parts in accordance with the embodiment of the present invention.

FIG. 5 is an arrangement example of the recessed parts in accordance with the embodiment of the present invention.

FIG. 6 is an arrangement example of the recessed parts in accordance with the embodiment of the present invention.

FIG. 7 is an arrangement example of the recessed parts in accordance with the embodiment of the present invention.

FIG. 8 (a) of FIG. 8 illustrates a process for applying, to a light blocking section formation mold, a material of which a light blocking section is made. (b) of FIG. 8 illustrates a process for pressing the light blocking section formation mold on a substrate. (c) of FIG. 8 illustrates a process for removing the light blocking section formation mold. (d) of FIG. 8 illustrates a process for forming a reflecting section on a top surface of the light blocking section. (e) of FIG. 8 illustrates a process for forming a light diffusing section.

FIG. 9 illustrates a cross section of a light-diffusion sheet in accordance with an embodiment of the present invention.

FIG. 10 (a) of FIG. 10 illustrates how a top surface of mesoporous silica is coated with a black coloring matter. (b) of FIG. 10 illustrates black mesoporous silica colored with the black coloring matter, and a cross section of the black mesoporous silica.

FIG. 11 (a) of FIG. 11 illustrates a process for applying, to a protruding part formation mold, a material of which a protruding part is made. (b) of FIG. 11 illustrates a process for pressing the protruding part formation mold on a substrate. (c) of FIG. 11 illustrates a process for removing the protruding part formation mold. (d) of FIG. 11 illustrates a process for forming a light blocking section on a top surface of the protruding part and forming a reflecting section on a top surface of the light blocking section. (e) of FIG. 11 illustrates a process for forming a light diffusing section.

FIG. 12 illustrates a cross section of a light-diffusion sheet in accordance with an embodiment of the present invention.

FIG. 13 (a) of FIG. 13 illustrates a process for applying, to a low refractive index light blocking section formation mold, a material of which a low refractive index light blocking section is made. (b) of FIG. 13 illustrates a process for pressing the low refractive index light blocking section formation mold on a substrate. (c) of FIG. 13 illustrates a process for removing the low refractive index light blocking section formation mold. (d) of FIG. 13 illustrates a process for forming a light diffusing section.

FIG. 14 is a cross-sectional view schematically illustrating a liquid crystal display device of an embodiment of the present invention.

FIG. 15 is a cross-sectional view schematically illustrating a liquid crystal panel and a light-diffusion sheet which constitute the liquid crystal display device of the embodiment of the present invention.

FIG. 16 (a) of FIG. 16 is a perspective view illustrating an example of a television receiver in accordance with an embodiment of the present invention. (b) of FIG. 16 is a perspective view illustrating an example of a personal computer in accordance with an embodiment of the present invention. (c) of FIG. 16 is a perspective view illustrating an example of a mobile phone in accordance with an embodiment of the present invention. (d) of FIG. 16 is a perspective view illustrating an example of a digital video camera in accordance with an embodiment of the present invention.

### DESCRIPTION OF EMBODIMENTS

### First Embodiment

(Schematic Arrangement of Light-Diffusion Sheet)

The following description discusses, with reference to FIG. 1, a schematic arrangement of a light-diffusion sheet 1 in accordance with the present embodiment. FIG. 1 illustrates a cross section of the light-diffusion sheet 1.

The light-diffusion sheet 1 is used by being provided on a front surface of a display screen of a transmission display device such as a liquid crystal display device. Specifically, the light-diffusion sheet 1 is used to diffuse light which is emitted from a backlight or the like to the display screen and exits toward an observer, so as to widen a viewing angle. In a case where the light-diffusion sheet 1 is provided in the transmission display device, a blind-like linear film called a louver may be provided between a light source and the light-diffusion sheet 1. Alternatively, the light source may be arranged to emit light which has been collimated or substantially collimated to parallel light.

The light-diffusion sheet 1 includes a light diffusing section 2, a light blocking section 3, a reflecting section 4, and a substrate (supporting film) 6 (see FIG. 1). Specifically, a plurality of light blocking sections 3 are provided on the substrate 6 and have respective triangular cross sections. The plurality of light blocking sections 3 are juxtaposed to each other so as to be spaced from each other. Top surfaces of the respective plurality of light blocking sections 3 are covered with respective reflecting sections 4. The light diffusing section 2 is further provided on the reflecting sections 4 so as to close a gap between the respective plurality of light blocking sections 3. Namely, in a case where the light diffusing section 2 is cut in its thickness direction, the light diffusing section 2 has a plurality of recessed parts 5 each of which has a substantially v-shaped cross section that narrows toward a light entrance surface (on a side opposite from the substrate surface 6).

Note that the light-diffusion sheet 1 is provided in a display device so that the light diffusing section 2 is located on a side from which light from the backlight or the like enters the light diffusing section 2. Namely, according to the light-diffusion sheet 1, the light from the backlight or the like enters the light diffusing section 2 and exits from the substrate 6 via the light diffusing section 2.

According to the present embodiment, the reflecting section 4 is made of mesoporous silica (a mesoporous silica nanoparticle) 8 which is uncolored. The mesoporous silica 8 is a particle which is made of silicon dioxide and has pores (mesopores) which are uniform and regular. The mesoporous silica 8 has a characteristic of having the pores (mesopores) whose diameter is approximately 2 nm to 50 nm. According to this, the mesoporous silica 8, which is porous, allows the reflecting section 4 to have a low refractive index. This increases a difference in refractive index between the reflecting section 4 and the light diffusing section 2, so that entrance light having entered the light-diffusion sheet 1 can be totally reflected with great efficiency. Further, the reflecting section 4, which can have a low refractive index, causes an increase in difference in refractive index between the light diffusing section 2 and the reflecting section 4 even if the light diffusing section 2 is not made of a high refractive index material. Accordingly, the light diffusing section 2 can be made of a widely-used material instead of an expensive material. This allows the light-diffusion sheet 1 to be made at a reduced manufacturing cost. This is specifically described below.

(Arrangement of the Light-Diffusion Sheet 1)

The following description discusses a specific arrangement of the light-diffusion sheet 1.

As described earlier, the top surfaces of the respective plurality of light blocking sections 3 are covered with the respective reflecting sections 4. The light diffusing section 2 is further provided on the reflecting sections 4 so as to close a gap between the respective plurality of light blocking sections 3. Accordingly, a light blocking section 3 is provided in a corresponding recessed part 5 provided in the light diffusing section 2, and a reflecting section 4 is provided between the light blocking section 3 and the corresponding recessed part 5.

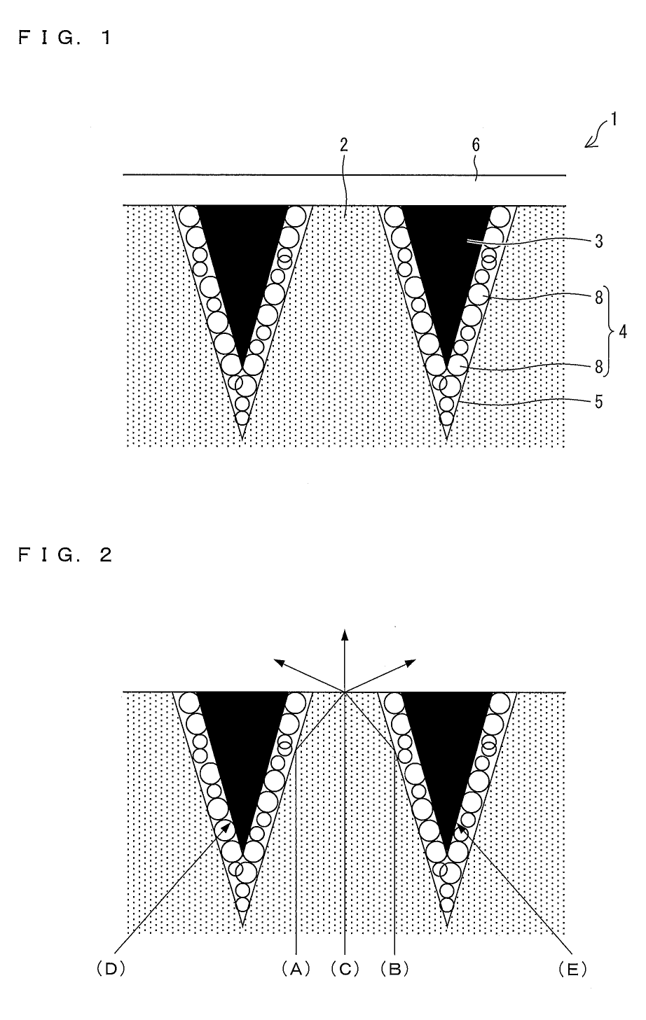

The following description discusses, with reference to FIG. 2, how entrance light having entered the light-diffusion sheet 1 exits. FIG. 2 schematically illustrates a principle of the light-diffusion sheet 1. In order to clarify reflection of light, FIG. 2 briefly illustrates the light-diffusion sheet 1.

The light-diffusion sheet 1 has a critical angle at which light that the light-diffusion sheet 1 can totally reflect enters the light-diffusion sheet 1. When light having entered the light-diffusion sheet 1 at an angle which does not exceed the critical angle reaches the recessed part 5 of the light diffusing section 2, the light is totally reflected in an interface between the reflecting section 4 and the light diffusing section 2, so that the light is diffused and exits (see arrows (A) and (B) illustrated in FIG. 2). Entrance light which is transmitted through the light diffusing section 2 without entering the recessed part 5 directly exits via the light diffusing section 2 (see an arrow (C) illustrated in FIG. 2).

In contrast, light having entered the light-diffusion sheet 1 at an angle which exceeds the critical angle is not totally reflected in the interface between the reflecting section 4 and the light diffusing section 2, so that the light is transmitted through a wall surface of the recessed part 5 and absorbed in the light blocking section 3 (see arrows (D) and (E) illustrated in FIG. 2). In a case where the light having been transmitted through the wall surface of the recessed part 5 passes through the light blocking section 3 toward the observer and is visually recognized by the observer, a decrease in front contrast and a blur in an image occurs. However, the light-diffusion sheet 1 prevents occurrence of a stray light by causing the light blocking section 3 to absorb light entering the light blocking section 3 through the recessed part 5. This prevents a decrease in front contrast and a blur in an image.

As described earlier, the light-diffusion sheet 1 has the following separate functional parts: (i) the functional part which totally reflects light having entered the light-diffusion sheet 1 and (ii) the functional part which absorbs a stray light having been transmitted through the wall surface of the recessed part 5. Namely, light having entered the light-diffusion sheet 1 is totally reflected in the interface between the reflecting section 4 and the light diffusing section 2. Therefore, according to the light-diffusion sheet 1, unlike a conventional light-diffusion sheet, it is unnecessary to use, for the light blocking section 3, a low refractive index material, and there is no problem with use of a material which has a high optical density (OD value). This can prevent a stray light having entered the light blocking section 3 from passing through the light blocking section 3 due to a low optical density of the light blocking section 3. Accordingly, a decrease in front contrast and a blur in an image can be substantially securely prevented.

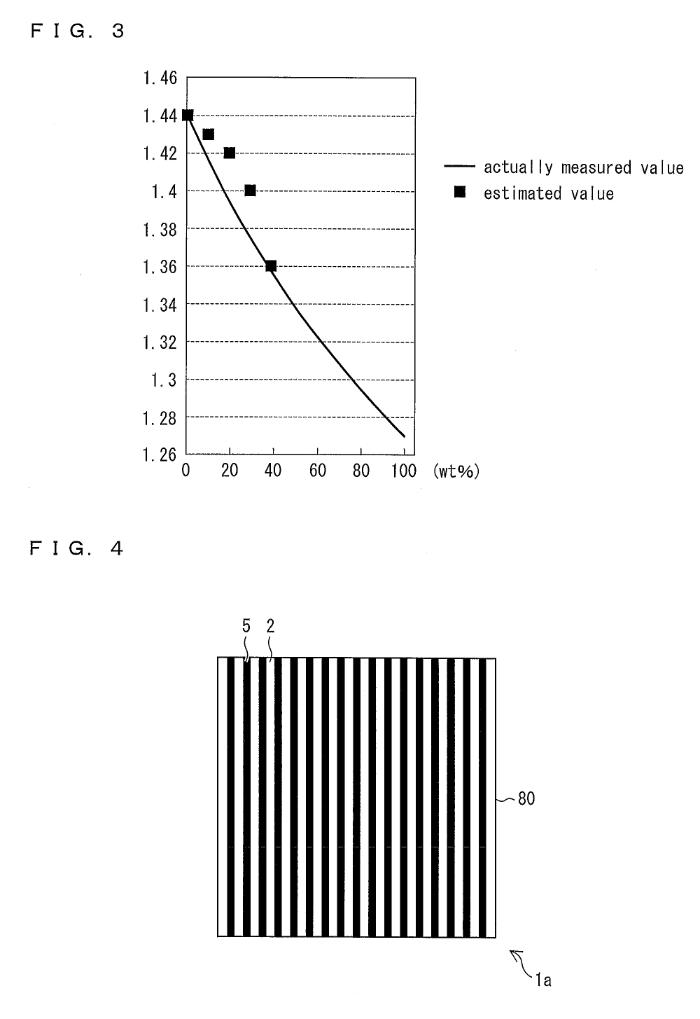

Note that, in a case where the critical angle increases at which the light that the light-diffusion sheet 1 can totally reflect enters the light-diffusion sheet 1, the light-diffusion sheet 1 can totally reflect a larger amount of light, so that an efficiency for light utilization can be enhanced. The critical angle increases as a difference in refractive index between the light diffusing section 2 and a part which has the interface with the light diffusing section 2 increases. Therefore, according to the present embodiment, it is preferable that a difference in refractive index between the light diffusing section 2 and the reflecting section 4 be large. In view of this, as described earlier, according to the present embodiment, the reflecting section 4 is made of the mesoporous silica 8. FIG. 3 is a graph of a refractive index of a resin containing the mesoporous silica 8. FIG. 3 shows a relationship between a concentration of the mesoporous silica 8 contained in the resin and a refractive index of the resin. As shown in FIG. 3, it is revealed that the resin has a smaller refractive index as the resin contains the mesoporous silica 8 in a higher concentration. Accordingly, in a case where the reflecting section 4 is made of the mesoporous silica 8, the reflecting section 4 has a small refractive index. This is because, in a case where a porous particle is mixed with a resin, the resin commonly has a small refractive index. A silica compound is exemplified by a particle called amorphous silica in addition to the mesoporous silica 8. However, the amorphous silica has a large average particle size of 100 nm and a small surface area of 7 m²/g. Accordingly, even in a case where the amorphous silica is mixed with a resin, the resin cannot have a lower refractive index. In contrast, the mesoporous silica 8 has an average particle size of not more than 30 nm and a large surface area of 1000 m²/g. Therefore, the reflecting section 4 which is made of the mesoporous silica 8 can have a smaller refractive index than the reflecting section 4 which is made of the amorphous silica. In particular, it is preferable that the reflecting section 4 have a thickness of at least 400 nm and contain the mesoporous silica 8 in a concentration of at least 10 wt %. If such a requirement is met, the reflecting section 4 can have a sufficiently low refractive index.

As described earlier, according to the light-diffusion sheet 1 in accordance with the present embodiment, the reflecting section 4 which is made of the mesoporous silica 8 is provided in the part which has the interface with the light diffusing section 2, and the mesoporous silica 8 causes the reflecting section 4 to have a small refractive index. This increases the difference in refractive index between the light diffusing section 2 and the reflecting section 4, so that the critical angle at which the light that the light-diffusion sheet 1 can totally reflect enters the light-diffusion sheet 1 increases in the light-diffusion sheet 1. As a result, the light-diffusion sheet 1 can totally reflect a larger amount of light, so that an efficiency for light utilization can be enhanced.

According to a conventional light-diffusion sheet, in order to increase a difference in refractive index between the light blocking section and the light diffusing section, the light blocking section needs to have a low refractive index, whereas the light diffusing section needs to have a high refractive index. This imposes a constraint on a material of which a light-diffusion sheet is made, so that the light-diffusion sheet needs to be made of an uncommon special resin or the like. This increases a material cost and consequently increases a manufacturing cost. However, as described earlier, the reflecting section 4 has a low refractive index. Therefore, according to the present embodiment, even if the light diffusing section 2 is not made of a high refractive index material, a difference in refractive index from the reflecting section 4 increases. Accordingly, the light diffusing section 2 can be made of a widely-used material instead of an expensive material. This allows the light-diffusion sheet 1 to be made at a reduced manufacturing cost.

According to a conventional light-diffusion sheet, light which enters the light-diffusion sheet substantially perpendicularly (light which enters the light-diffusion sheet from a region which is at an angle of ±10° with respect to a direction that is perpendicular to the light-diffusion sheet) can be totally reflected with great efficiency. However, light which enters the light-diffusion sheet from a region which is at an angle of more than ±10° with respect to the direction that is perpendicular to the light-diffusion sheet is utilized inefficiently. In contrast, according to the light-diffusion sheet 1 in accordance with the present embodiment, the difference in refractive index between the light diffusing section 2 and the reflecting section 4 is large. Therefore, light which enters the light-diffusion sheet 1 from a region which is at an angle of not less than ±10° with respect to a direction that is perpendicular to the light-diffusion sheet 1 is utilized with higher efficiency. For example, in a case where the reflecting section 4 has a thickness of not less than 800 nm and contains the mesoporous silica 8 in a concentration of not less than 10 wt %, it is possible to increase, by 80%, an efficiency for utilization of the light which enters the light-diffusion sheet 1 from the region which is at an angle of not less than ±10° with respect to the direction that is perpendicular to the light-diffusion sheet 1. This allows an increase in efficiency for light utilization by 30% in the entire light-diffusion sheet.

According to the present embodiment, the reflecting section 4 is provided between the recessed part 5 and the light blocking section 3, and the reflecting section 4 is provided so as to cover the entire wall surface of the recessed part 5. This can prevent a contact of the light blocking section 3 with the wall surface of the recessed part 5. Light having entered a part in which the light blocking section 3 is in contact with the wall surface of the recessed part 5 is absorbed in the light blocking section 3 without being totally reflected in the interface with the light diffusing section 2. Accordingly, the reflecting section 4 which is provided between the light blocking section 3 and the recessed part 5 can prevent a reduction in efficiency for light utilization due to the contact of the light blocking section 3 with the wall surface of the recessed part. However, how to provide the reflecting section 4 is not necessarily limited to this. It is only necessary that the reflecting section 4 be provided in at least a part of the wall surface of the recessed part 5. Specifically, it is only necessary that the reflecting section 4 be provided in a region which is at least 10% of the wall surface of the recessed part 5. As described above, the reflecting section 4 which is provided in at least a part of the wall surface of the recessed part 5 can sufficiently totally reflect light having entered the light-diffusion sheet 1.

Note that, in a case where entrance light having entered the light-diffusion sheet 1 is totally reflected in accordance with Snell's law, an effusion of light called an evanescent wave occurs. The effusion of light occurs in a length which is substantially equivalent to a wavelength. Therefore, the entrance light can be totally reflected only when the reflecting section 4 has a thickness which is not less than a wavelength. Since visible light has a maximum wavelength of 800 nm, it is preferable that the reflecting section 4 have a thickness of not less than 800 nm. According to the light-diffusion sheet 1 in accordance with the present embodiment, the reflecting section 4 can easily have a thickness of not less than 800 nm.

According to the present embodiment, the light blocking section 3 is provided so as to reach a vicinity of the deepest part of the recessed part 5. This allows the light blocking section 3 to substantially securely absorb even a stray light having entered the vicinity of the deepest part of the recessed part 5.

As described earlier, as a resin contains the mesoporous silica 8 in a higher concentration, the resin has a smaller refractive index. Namely, in other words, in a case where a concentration of the mesoporous silica 8 contained in a resin can adjust a refractive index of the resin. Accordingly, in a case where a concentration of the mesoporous silica 8 constituting the reflecting section 4 is adjusted, the reflecting section 4 can have a desired refractive index.

Note that it is preferable that each of the plurality of recessed parts 5 of the light diffusing section 2 has a substantially conical or pyramidal shape such as a circular cone or a quadrangular pyramid which narrows toward the light entrance surface and has a v-shaped cross section. According to this, a single light-diffusion sheet can diffuse light with great efficiency, so that a wide viewing angle can be obtained. However, a shape of the recessed part 5 is not limited to this. It is only necessary that the recessed part 5 have a shape which allows light to be diffused in at least vertical and horizontal directions. For example, two oblique sides of a cross section of the recessed part 5 do not need to be in symmetry with each other, the recessed part 5 may have a polygonal cross section, or the recessed part 5 may have a curved surface. Alternatively, the plurality of recessed parts 5 may be grooves which have respective v-shaped cross sections, and the grooves may be juxtaposed to each other on the light exit surface side of the light diffusing section 2. In this case, it is only necessary that two light-diffusion sheets 1 be used by combining the two light-diffusion sheets 1 so that grooves provided in the respective two light-diffusion sheets 1 are orthogonal to each other. Note that it is only necessary that a shape of the light blocking section 3 be determined in view of a shape of the recessed part 5.

Note that the present example takes, as an example, a case where all the plurality of recessed parts 5 have an identical depth. However, the light-diffusion sheet 1 of the present invention is not limited to this. For example, the plurality of recessed parts 5 may have different depths.

As described earlier, it is only necessary that the recessed part 5 have a shape which allows light to be diffused in at least vertical and horizontal directions. In view of this, FIGS. 4 through 7 show respective arrangement examples of the recessed part 5. A reference number 80 shown in each of FIGS. 4 through 7 refers to a light exit surface which causes entrance light to exit, the entrance light having entered a light-diffusion sheet and been diffused in the light-diffusion sheet.

The plurality of recessed parts 5 may be periodically provided in a one-dimensional direction in the light exit surface 80 of a light-diffusion sheet 1a (see FIG. 4). Namely, the plurality of recessed parts 5 form respective grooves which extend throughout a vertical length or a horizontal length of the light-diffusion sheet 1a along a side (a vertical side or a horizontal side) of the light exit surface 80 of the light-diffusion sheet 1a. The plurality of recessed parts 5 may be juxtaposed to each other at regular intervals.

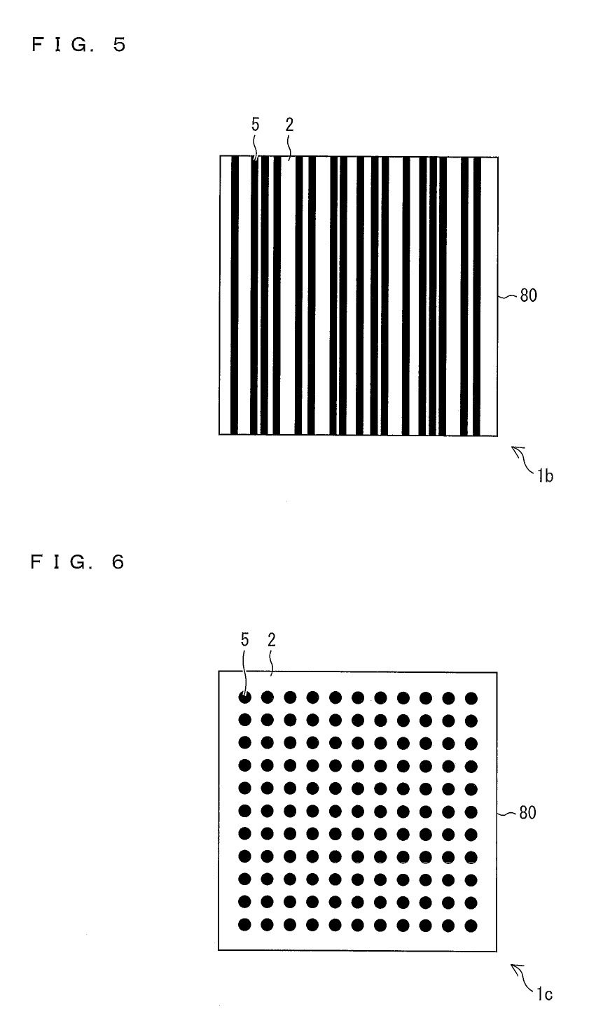

Note that how to provide the plurality of recessed parts 5 is not limited to this. For example, the plurality of recessed parts 5 may be non-periodically provided in a one-dimensional direction in the light exit surface 80 of a light-diffusion sheet 1b (see FIG. 5). Namely, the plurality of recessed parts 5 form respective grooves which extend throughout a vertical length or a horizontal length of the light-diffusion sheet 1b along a side (a vertical side or a horizontal side) of the light exit surface 80 of the light-diffusion sheet 1b. The plurality of recessed parts 5 may be juxtaposed to each other at random intervals.

According to this, the plurality of recessed parts 5 are randomly provided. This can prevent a moire which occurs between the light-diffusion sheet 1b and a periodic structure which is existing in a display device to which the light-diffusion sheet 1b is applied. Further, light which is transmitted through the light-diffusion sheet 1b can prevent interference which is caused by a structure such as the plurality of recessed parts 5 which are periodically provided.

The plurality of recessed parts 5 may be periodically provided in a two-dimensional direction in the light exit surface 80 of a light-diffusion sheet 1c (see FIG. 6). Namely, each of the plurality of recessed parts 5 has a substantially conical or pyramidal shape. The plurality of recessed parts 5 may be provided in a dot pattern when seen from the light exit surface 80 side. The plurality of recessed parts 5 each of which has a substantially conical or pyramidal shape may be provided vertically and horizontally in a matrix pattern (in a grid pattern) at regular intervals in the light exit surface 80 of the light-diffusion sheet 1c.

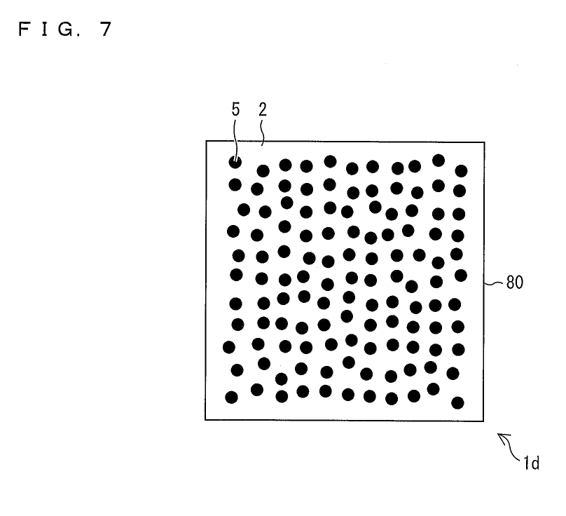

Further, how to provide the plurality of recessed parts 5 is not limited to this. For example, the plurality of recessed parts 5 may be non-periodically provided in a two-dimensional direction in the light exit surface 80 of a light-diffusion sheet 1d (see FIG. 7). Namely, the plurality of recessed parts 5, each of which has a substantially conical or pyramidal shape, may be provided vertically and horizontally at random intervals in the light exit surface 80 of the light-diffusion sheet 1d. In this case, the plurality of recessed parts 5 are not provided in a matrix pattern.

According to this, the plurality of recessed parts 5 are randomly provided. This can prevent a moire which occurs between the light-diffusion sheet 1d and a periodic structure which is existing in a display device to which the light-diffusion sheet 1d is applied. Further, light which is transmitted through the light-diffusion sheet 1d can prevent interference which is caused by a structure such as the plurality of recessed parts 5 which are periodically provided.

(Members of the Light-Diffusion Sheet 1)

The following description discusses members constituting the light-diffusion sheet 1.

The light diffusing section 2 transmits light having entered the light diffusing section 2 from its light entrance surface side toward the substrate 6 provided on the light exit surface side of the light diffusing section 2, so as to cause the light thus having been transmitted to exit. Accordingly, the light diffusing section 2 is made of a material which can transmit entrance light. In view of a transmissivity, it is preferable that the light diffusing section 2 be made of a transparent resin. It is more preferable that the light diffusing section 2 be made of a UV curable material. This further simplifies operation during formation of the light-diffusion sheet 1. Note that, as described earlier, even if the light diffusing section 2 is not made of a high refractive index material, a difference in refractive index from the reflecting section 4 increases. Accordingly, it is only necessary that the light diffusing section 2 be made of a material which has a moderate refractive index and is exemplified by, for example, Epo-Tek (Registered Trademark), epoxyacrylate, and a transparent resin such as vinyl chloride resin, styrene resin, urethane resin, polyester resin, acrylic resin, or polycarbonate resin. The above description shows specific examples of the material of which the light diffusing section 2 is made. However, the material of which the light diffusing section 2 is made is not necessarily limited to these.

A material of which the light blocking section 3 is made is exemplified by a resin such as urethane resin which contains a pigment such as carbon black that is commonly used for a black matrix. In addition to this, a metal such as low-reflection chrome, a low-reflection duplex nickel alloy, or a film in which molybdenum (Mo) and molybdenum oxide (MoOx) are stacked, or a combination of any one of these materials and a resin is also applicable to the light blocking section 3. As described earlier, unlike a conventional light blocking section, the light blocking section 3 does not need to be made of a low refractive index material. Therefore, in a case where the light blocking section 3 is made of a resin which contains a pigment, a high refractive index resin is also usable. Further, there is no problem with use of a material which has a high OD value.

The substrate 6 is made of a transparent material so that light (image light) of a display device can exit from the substrate 6. Such a transparent material is exemplified by a base film material such as polyethylene terephthalate, polycarbonate, polyester, acryl, polyolefin, polypropylene, or vinyl. However, the transparent material is not necessarily limited to these.

(Method for Manufacturing the Light-Diffusion Sheet 1)

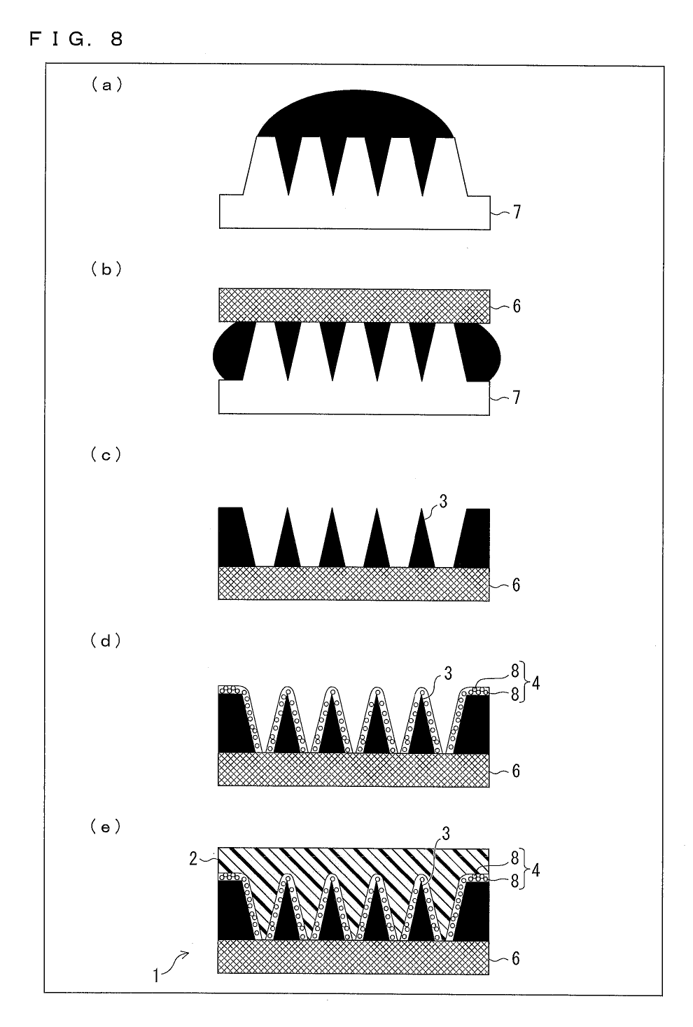

The following description discusses, with reference to FIG. 8, a method for manufacturing the light-diffusion sheet 1. (a) of FIG. 8 illustrates a process for applying, to a light blocking section formation mold 7, a material of which the light blocking section 3 is made. (b) of FIG. 4 illustrates a process for pressing the light blocking section formation mold 7 on the substrate 6. (c) of FIG. 8 illustrates a process for removing the light blocking section formation mold 7. (d) of FIG. 8 illustrates a process for forming the reflecting section 4 on a top surface of the light blocking section 3. (e) of FIG. 8 illustrates a process for forming the light diffusing section 2.

For example, a manufacturing method disclosed in Japanese Patent Application Publication, Tokukai, No. 2009-63849 A may be used as the method for manufacturing the light-diffusion sheet 1 in accordance with the present embodiment. Specifically, first, the plurality of light blocking sections 3 are formed. A material of which the plurality of light blocking sections 3 are made is applied to the light blocking section formation mold 7 which has a plurality of recessed parts that have opposite shapes from the plurality of light blocking sections 3 (see (a) of FIG. 8). Specifically, a molding two-part urethane resin solution in which carbon black is mixed in an amount of 5 wt % is applied. Next, an acrylic resin substrate which serves as the substrate 6 and is a square of a side 30 mm is pressed on the light blocking section formation mold 7 to which the material of which the plurality of light blocking sections 3 are made has been applied (see (b) of FIG. 84). The plurality of light blocking sections 3 are cured with the substrate 6 pressed thereon. In this case, if a two-part urethane resin solution is used, two types of solutions are mixed and is reaction cured in several tens of minutes. Therefore, the two-part urethane resin solution is applied to the light blocking section formation mold 7 immediately after the two types of solutions are mixed. In a case where the light blocking section formation mold 7 is removed after the plurality of light blocking sections 3 are sufficiently cured, the plurality of light blocking sections 3 are juxtaposed to each other on the substrate 6 (see (c) of FIG. 8).

Subsequently, the reflecting sections 4 are formed. A material of which the reflecting sections 4 are made is applied to the respective plurality of light blocking sections 3 (see (d) of FIG. 8). Specifically, a stirred mixture of the mesoporous silica 8 and Epo-Tek (Registered Trademark) is applied one time by a spray method. Thereafter, the reflecting sections 4 are cured by UV irradiation.

Finally, the light diffusing section 2 is formed. The light diffusing section 2 is formed on the plurality of light blocking sections 3 on which the respective reflecting sections 4 have been formed (see (e) of FIG. 8). Specifically, Epo-Tek (Registered Trademark) is applied by the spray method so as to cause the light diffusing section 2 to have a height of approximately 100 μm and to close a gap between the respective plurality of light blocking sections 3. Thereafter, the light diffusing section 2 is cured by UV irradiation. The light-diffusion sheet 1 is thus formed.

The above description discusses the method for manufacturing the light-diffusion sheet 1 by use of a specific example. However, the method for manufacturing the light-diffusion sheet 1 in accordance with the present embodiment is not necessarily limited to this. For example, the light-diffusion sheet 1 can be manufactured by use of a dip method, a spin coating method, or the like other than the spray method.

Note that according to the above description, the reflecting sections 4 are made of a mixture of the mesoporous silica 8 and the material of which the light diffusing section 2 is made. According to this, a material of which the reflecting sections 4 are made can be directly used to form the light diffusing section 2. This allows a reduction in material for use in forming the light-diffusion sheet 1. However, the material of which the reflecting sections 4 are made is not necessarily limited to this. The reflecting sections 4 may be made of a mixture of the mesoporous silica 8 and another material which is different from the material of which the light diffusing section 2 is made. The another material is exemplified by a UV curable resin and an electron radiation curable resin each of which is transparent and has a predetermined refractive index and an ionizing radiation curing function. Specifically, a reactive oligomer resin such as epoxyacrylate resin, urethane acrylate resin, polyether acrylate resin, polyester acrylate resin, or polythiol resin, or a reactive monomer resin such as vinylpyrrolidone, 2-ethylhexylacrylate, β-hydroxyacrylate, or tetrahydrofurfurylacrylate is appropriately selected. Some of these resins are directly cured by ionizing radiation. However, these resins commonly start a curing reaction via a catalyst or an initiator (a substance which excites a reaction).

For example, in order to cause a curing reaction by use of ultraviolet rays having a wavelength of 300 nm to 400 nm, it is necessary to mix several % of a photoinitiator which excites a reaction in a ultraviolet range. The photoinitiator is exemplified by a ketone photoinitiator and an acetophenone photoinitiator. For example, Sandray 1000, Darocure1163, Darocure1173, Irgacure183, Irgacure651, or the like is applicable. As described above, an appropriate photoinitiator is selected in accordance with, for example, a type (wavelength characteristic) of ionizing radiation for use in curing.

### Second Embodiment

(Arrangement of Light-Diffusion Sheet 11)

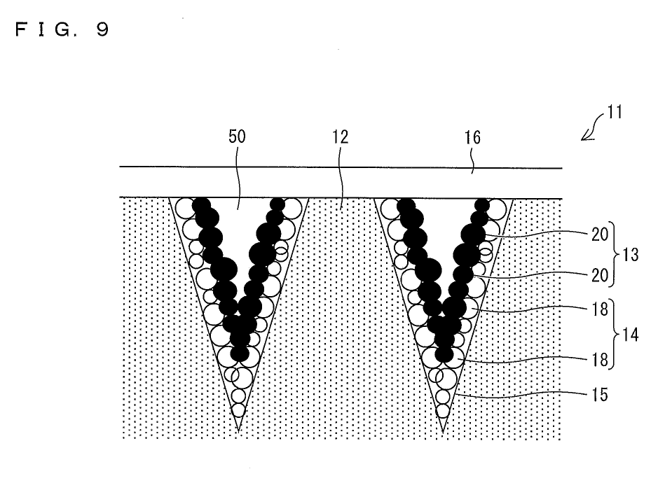

The reflecting section 4 is made of the mesoporous silica 8 in the First Embodiment. Not only the reflecting section 4 but also the light blocking section 3 may be made of the mesoporous silica 8. This allows a reduction in cost of manufacturing the light-diffusion sheet 1. This is specifically described below with reference to FIG. 9. FIG. 9 illustrates a cross section of a light-diffusion sheet 11.

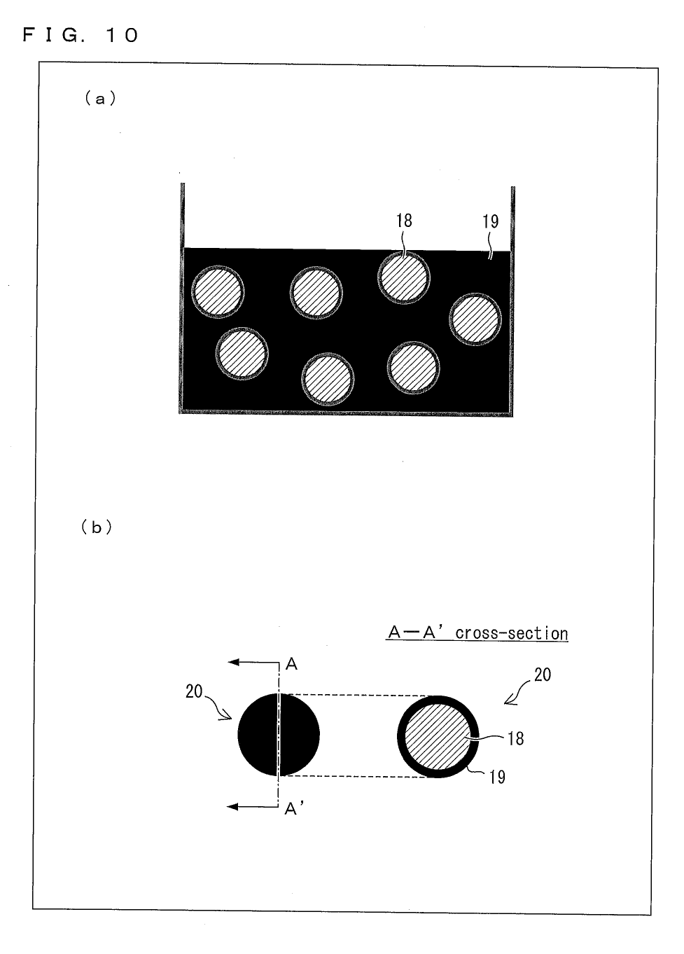

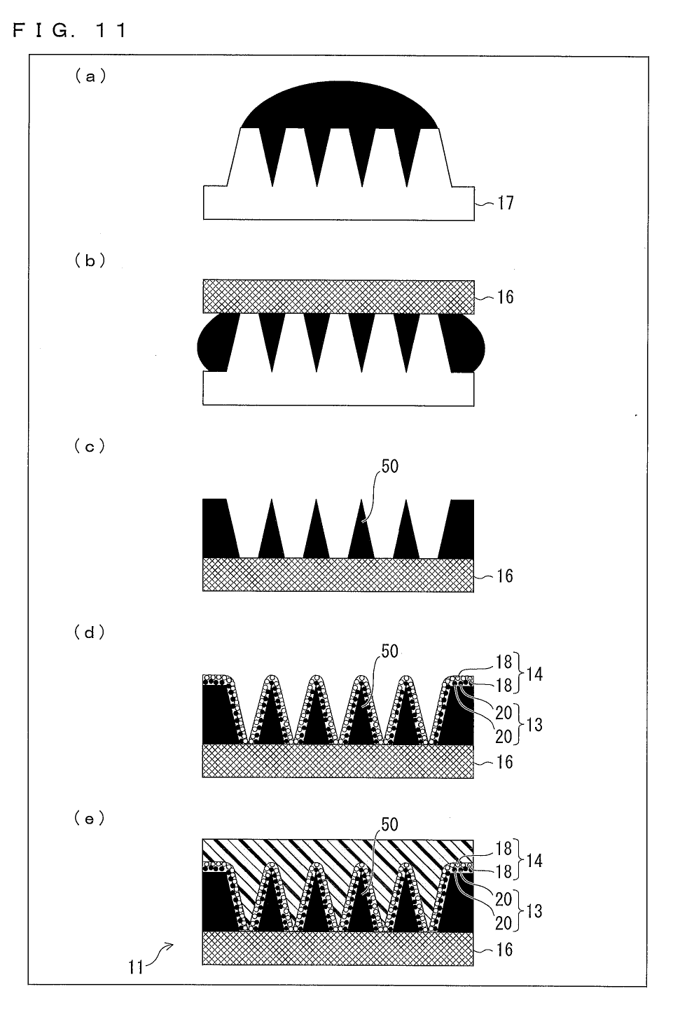

A reflecting section 14 is provided so as to cover a wall surface of a recessed part 15 of a light diffusing section 12, and the reflecting section 14 is made of mesoporous silica 18 (see FIG. 9). Further, a light blocking section 13 is provided so as to cover a top surface of the reflecting section 14. Specifically, the light blocking section 13 is made of the mesoporous silica 18 (black mesoporous silica 20) whose top surface is coated with a black coloring matter. FIG. 10 shows how a method for coating the mesoporous silica 18 is carried out. (a) of FIG. 10 illustrates how a top surface of the mesoporous silica 18 is coated with a black coloring matter 19. (b) of FIG. 10 illustrates the black mesoporous silica 20 colored with the black coloring matter 19, and a cross section of the black mesoporous silica 20.

First, the mesoporous silica 18 is mixed in a vessel in which the black coloring matter 19 is contained (see (a) of FIG. 10). Then, the top surface of the mesoporous silica 18 is coated with the black coloring matter 19 by, for example, a physical adsorption method or a chemical adsorption method. In this case, carbon black or an azine compound is usable as the black coloring matter 19. It is preferable that the physical adsorption method be employed in a case where carbon black is used and that the chemical adsorption method be employed in a case where an azine compound is used. The black mesoporous silica 20 thus formed has a top surface which is coated in black and an inner part in which the mesoporous silica 18 remains (see (b) of FIG. 10).

According to the arrangement, the mesoporous silica 18 of which the reflecting section 14 is made allows the reflecting section 14 to have a low refractive index. This increases a difference in refractive index between the reflecting section 14 and the light diffusing section 12, so that entrance light having entered the light-diffusion sheet 11 can be totally reflected with great efficiency. Further, the light blocking section 13 absorbs light which is transmitted through the wall surface of the recessed part 15 and enters the light blocking section 13. This can prevent occurrence of a stray light. As described above, according to the light-diffusion sheet 11 in which the light blocking section 13 is made of the black mesoporous silica 20, an effect can be obtained which is similar to an effect of the light-diffusion sheet 1 in accordance with the First Embodiment.

Further, merely covering a wall surface of the reflecting section 14 allows the light blocking section 13 to sufficiently absorb light having entered the light blocking section 13. Accordingly, it is only necessary that the light blocking section 13 be formed so as to cover the wall surface of the reflecting section 14. This allows a reduction in amount of use of the black mesoporous silica 20. Therefore, a material cost of the light-diffusion sheet 11 can be reduced and consequently a manufacturing cost can be reduced. Note that a space defined by the light blocking section 13 and a substrate 16 may be filled with a resin or the like, so as to be provided with a protruding part 50. Alternatively, the space may be filed with the black mesoporous silica 20 or remain vacant. In a case where the protruding part 50 is provided, it is preferable that the protruding part 50 be made of a UV curable material. This further simplifies operation during formation of the light-diffusion sheet 11. Such a material that is applicable is exemplified by epoxyacrylate having an ionizing radiation curing function.

(Method for Manufacturing the Light-Diffusion Sheet 11)

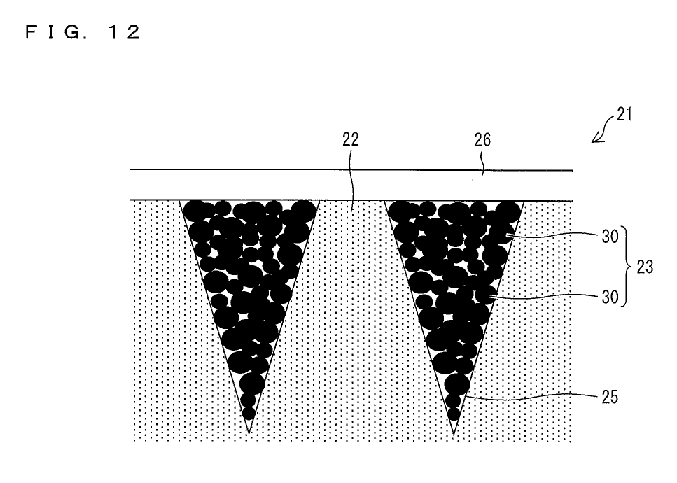

The following description discusses, with reference to FIG. 7, a method for manufacturing the light-diffusion sheet 11. (a) of FIG. 11 illustrates a process for applying, to a protruding part formation mold 17, a material of which the protruding part 50 is made. (b) of FIG. 11 illustrates a process for pressing the protruding part formation mold 17 on the substrate 16. (c) of FIG. 11 illustrates a process for removing the protruding part formation mold 17. (d) of FIG. 11 illustrates a process for forming the light blocking section 13 on a top surface of the protruding part 50 and forming the reflecting section 14 on a top surface of the light blocking section 13. (e) of FIG. 11 illustrates a process for forming the light diffusing section 12.

For example, the manufacturing method disclosed in Japanese Patent Application Publication, Tokukai, No. 2009-63849 A may be used also in the present embodiment as the method for manufacturing the light-diffusion sheet 11. The method for manufacturing the light-diffusion sheet 11 is not specifically mentioned here since the method is similar to the method described in the First Embodiment. The following description schematically discusses how the method for manufacturing the light-diffusion sheet 11 is carried out.

First, the protruding part 50 with which the space defined by the light blocking section 13 and the substrate 16 is filled is formed. A material of which a plurality of protruding parts 50 are made is applied to the protruding part formation mold 17 which has a plurality of recessed parts that have opposite shapes from the plurality of protruding parts 50 (see (a) of FIG. 11). Next, the substrate 16 is pressed on the protruding part formation mold 17 to which the material of which the plurality of protruding parts 50 are made has been applied, and the plurality of protruding parts 50 are cured with the substrate 16 pressed thereon. (see (b) of FIG. 11). In a case where the protruding part formation mold 17 is removed after the plurality of protruding parts 50 are sufficiently cured, the plurality of protruding parts 50 are juxtaposed to each other on the substrate 16 (see (c) of FIG. 11).

Next, light blocking sections 13 are formed. A material of which the light blocking sections 13 are made is applied to the respective plurality of protruding parts 50 by the spray method. Thereafter, the light blocking sections 13 are cured by UV irradiation.

Subsequently, reflecting sections 14 are formed. A material of which the reflecting sections 14 are made is applied to the respective plurality of light blocking sections 13. Thereafter, the reflecting sections 14 are cured by UV irradiation. According to this, a stacked layer is formed in which the light blocking sections 13 and the reflecting sections 14 are stacked on the respective plurality of protruding parts 50 (see (d) of FIG. 11).

Finally, the light diffusing section 12 is formed. To the plurality of protruding parts 50 on which the respective reflecting sections 14 are provided, a material of which the light diffusing section 12 is made is applied by the spray method so as to close a gap between the respective plurality of protruding parts 50 (see (e) of FIG. 11). Thereafter, the light diffusing section 12 is cured by UV irradiation. The light-diffusion sheet 11 is thus formed.

The above description discusses the method for manufacturing the light-diffusion sheet 11 by the spray method. However, the method for manufacturing the light-diffusion sheet 11 in accordance with the present embodiment is not necessarily limited to this. For example, the light-diffusion sheet 1 can be manufactured by use of a dip method, a spin coating method, or the like other than the spray method.

The above description discusses the method for manufacturing the light-diffusion sheet 11 which has a protruding part 50. However, as described earlier, a space defined by a light blocking section 13 and the substrate 16 may be filled with the black mesoporous silica 20 or remain vacant. For example, in a case where the space defined by the light blocking section 13 and the substrate 16 is filled with the black mesoporous silica 20, the light blocking section 13 may be formed by a method for forming the protruding part 50. This allows a process for forming the light-diffusion sheet 11 to be simpler.

In contrast, in a case where the space defined by a light blocking section 13 and the substrate 16 remains vacant, it is only necessary that the light diffusing section 12 be formed first. Specifically, the light diffusing section 12 which has recessed parts 15 is formed by pressing, on a material of which the light diffusing section 12 is made, a mold which has a plurality of protruding parts that have opposite shapes from the recessed parts 15. Then, the material of which the reflecting sections 14 are made is applied to inner parts of the respective recessed parts 15 of the light diffusing section 12 so as to cover wall surfaces of the respective recessed parts 15. Further, the material of which the light blocking sections 13 are made is applied so as to cover top surfaces of the respective reflecting sections 14. Finally, the substrate 16 is formed on a side of the light diffusing section 12 on which side the recessed parts 15 are provided. This allows a space defined by a light blocking section 13 and the substrate 16 to be vacant. This method allows a further reduction in material cost since nothing needs to be provided in the space.

Note that the reflecting sections 14 may be made of a mixture of the mesoporous silica 18 and the material of which the light diffusing section 12 is made. This allows a reduction in material for use in forming the light-diffusion sheet 11. According to this, the material of which the reflecting sections 14 are made can be directly used to form the light diffusing section 12. However, the material of which the reflecting sections 14 are made is not necessarily limited to this. The reflecting sections 14 may be made of a mixture of the mesoporous silica 18 and another material which is different from the material of which the light diffusing section 2 is made. The another material is exemplified by a UV curable resin and an electron radiation curable resin each of which is mentioned in the First Embodiment. Same applies to formation of the light blocking sections 13.

### Third Embodiment

(Arrangement of Light-Diffusion Sheet 21)

According to the Second Embodiment, the light blocking sections 13 is made of the black mesoporous silica 20. RUBCOULEUR (manufactured by Dainichiseika Color & Chemicals Mfg. Co., Ltd.) is commonly known as a particle which absorbs light. RUBCOULEUR, whose chief ingredient is acrylcopolymer, is a particle which can be colored with a pigment. RUBCOULEUR colored with a pigment such as carbon black exhibits light absorptivity. Accordingly, it seems that RUBCOULEUR is applicable instead of each of the mesoporous silica 18 and the black mesoporous silica 20. However, mixing of RUBCOULEUR and a resin causes the resin to have a high refractive index. Namely, a difference in refractive index between the reflecting sections 14 and the light diffusing section 12 becomes small. This prevents entrance light having entered the light-diffusion sheet 11 from being totally reflected with great efficiency.

In contrast, as described earlier, mixing of the mesoporous silica 18 and a resin causes a reduction in refractive index of the resin. Mixing of a resin and the black mesoporous silica 20 whose top surface is coated with the black coloring matter 19 also causes a reduction in refractive index of the resin. This is because, since only the top surface of the black mesoporous silica 20 is coated with the black coloring matter 19, the refractive index of the resin is not affected. Therefore, given that mixing of a resin and the black mesoporous silica 20 also causes a reduction in refractive index of the resin, the light blocking sections 13 and the reflecting sections 14 may be made of the black mesoporous silica 20. Namely, the black mesoporous silica 20 may serve as both the light blocking sections 13 and the reflecting sections 14. This is to be described with reference to FIG. 12. FIG. 12 illustrates a cross section of a light-diffusion sheet 21.

An inner part of a recessed part 25 of a light diffusing section 22 is filled with black mesoporous silica 30 (see FIG. 12). Specifically, a low refractive index light blocking section 23 is formed by filling the inner part of the recessed part 25 with the black mesoporous silica 30 which is coated with a black coloring matter 19 as in the case of the Second Embodiment. As described earlier, the black mesoporous silica 30 has a function as a reflecting section since mixing of the black mesoporous silica 30 and a resin allows the resin to have a low refractive index. Further, the black mesoporous silica 30, which can absorb light, also has a function as a light blocking section. Accordingly, the low refractive index light blocking section 23 can serve as both the light blocking section and the reflecting section. According to the arrangement, the black mesoporous silica 30 of which the low refractive index light blocking section 23 is made allows the low refractive index light blocking section 23 to have a low refractive index. This increases a difference in refractive index between the low refractive index light blocking section 23 and the light diffusing section 22, so that entrance light having entered the light-diffusion sheet 21 can be totally reflected with great efficiency. Further, the low refractive index light blocking section 23 absorbs light which is transmitted through a wall surface of the recessed part 25 and enters the low refractive index light blocking section 23. This can prevent occurrence of a stray light. As described above, according to the light-diffusion sheet 21 in which the low refractive index light blocking section 23 is formed by filling the inner part of the recessed part 25 with the black mesoporous silica 30, an effect can be obtained which is similar to the effect of the light-diffusion sheet 1 in accordance with the First Embodiment.

Further, the black mesoporous silica 30 has a large surface area of 1000 m²/g. Therefore, the low refractive index light blocking section 23 made of the black mesoporous silica 30 has a high OD value. This improves light absorptivity of the low refractive index light blocking section 23 made of the black mesoporous silica 30. Therefore, the low refractive index light blocking section 23 can substantially securely absorb a stray light having entered the low refractive index light blocking section 23 and prevent the stray light from passing therethrough.

In addition, the black mesoporous silica 30 has a small average particle size of not more than 30 nm. Therefore, the recessed part 25 can be filled with the black mesoporous silica 30 so that substantially no space is left in the recessed part 25. Accordingly, for example, even in a case where (i) the recessed part 25 of the light-diffusion sheet 1 is small or (ii) an opening of the recessed part 25 is small, the black mesoporous silica 30 is applicable to the light-diffusion sheet 21 with no problem. Further, the black mesoporous silica 30 is also applicable to the light-diffusion sheet 1 which employs a moth eye formation technique.

(Method for Manufacturing the Light-Diffusion Sheet 21)

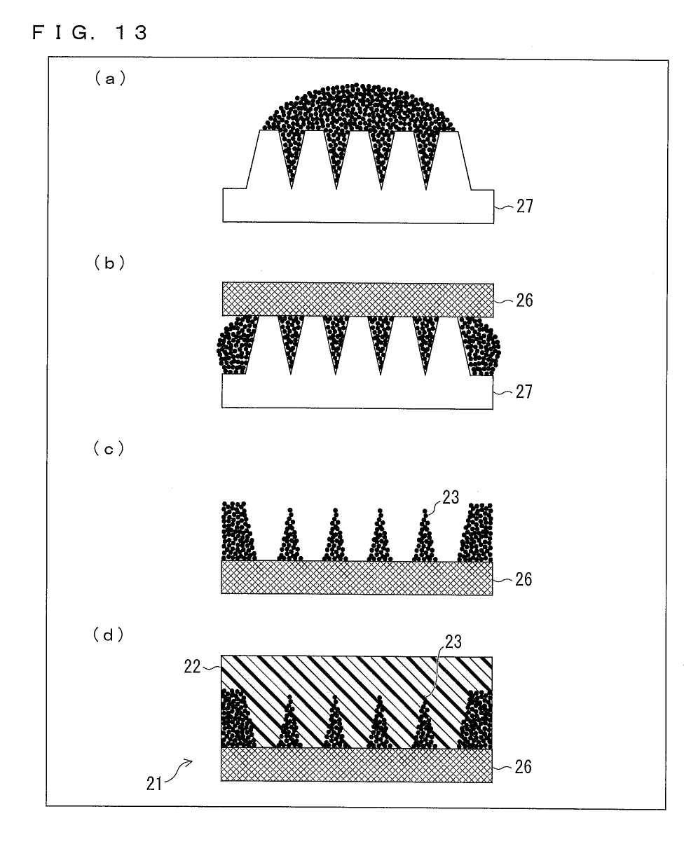

The following description discusses, with reference to FIG. 9, a method for manufacturing the light-diffusion sheet 21. (a) of FIG. 13 illustrates a process for applying, to a low refractive index light blocking section formation mold 27, a material of which the low refractive index light blocking section 23 is made. (b) of FIG. 13 illustrates a process for pressing the low refractive index light blocking section formation mold 27 on the substrate 26. (c) of FIG. 13 illustrates a process for removing the low refractive index light blocking section formation mold 27. (d) of FIG. 13 illustrates a process for forming the light diffusing section 22.

For example, the manufacturing method disclosed in Japanese Patent Application Publication, Tokukai, No. 2009-63849 A may be used also in the present embodiment as the method for manufacturing the light-diffusion sheet 21. The method for manufacturing the light-diffusion sheet 21 is not specifically mentioned here since the method is similar to the method described in the First Embodiment. The following description schematically discusses how the method for manufacturing the light-diffusion sheet 21 is carried out.

First, the low refractive index light blocking section 23 is formed. A material of which a plurality of low refractive index light blocking sections 23 are made is applied to the low refractive index light blocking section formation mold 27 which has a plurality of recessed parts that have opposite shapes from the plurality of low refractive index light blocking sections 23 (see (a) of FIG. 13). Next, the substrate 26 is pressed on the low refractive index light blocking section formation mold 27 to which the material of which the plurality of low refractive index light blocking sections 23 are made has been applied, and the plurality of low refractive index light blocking sections 23 are cured with the substrate 26 pressed thereon. (see (b) of FIG. 13). In a case where the low refractive index light blocking section formation mold 27 is removed after the plurality of low refractive index light blocking sections 23 are sufficiently cured, the plurality of low refractive index light blocking sections 23 are juxtaposed to each other on the substrate 26 (see (c) of FIG. 13).

Finally, to the plurality of low refractive index light blocking sections 23, a material of which the light diffusing section 22 is made is applied by the spray method so as to close a gap between the respective plurality of low refractive index light blocking sections 23 (see (d) of FIG. 13). Thereafter, the light diffusing section 22 is cured by UV irradiation. The light-diffusion sheet 21 is thus formed.

The above description discusses the method for manufacturing the light-diffusion sheet 21 by the spray method. However, the method for manufacturing the light-diffusion sheet 21 in accordance with the present embodiment is not necessarily limited to this. For example, the light-diffusion sheet 21 can be manufactured by use of a dip method, a spin coating method, or the like other than the spray method.

Note that the plurality of low refractive index light blocking sections 23 may be made of a mixture of mesoporous silica 28 and the material of which the light diffusing section 22 is made. This allows a reduction in material for use in forming the light-diffusion sheet 22. According to this, the material of which the plurality of low refractive index light blocking sections 23 are made can be directly used to form the light diffusing section 22. However, the material of which the plurality of low refractive index light blocking sections 23 are made is not necessarily limited to this. The plurality of low refractive index light blocking sections 23 may be made of a mixture of the mesoporous silica 28 and another material which is different from the material of which the light diffusing section 2 is made. The another material is exemplified by a UV curable resin and an electron radiation curable resin each of which is mentioned in the First Embodiment.

The present invention is not limited to the description of the embodiments above, but may be altered by a skilled person within the scope of the claims. An embodiment based on a proper combination of technical means disclosed in different embodiments is encompassed in the technical scope of the present invention.

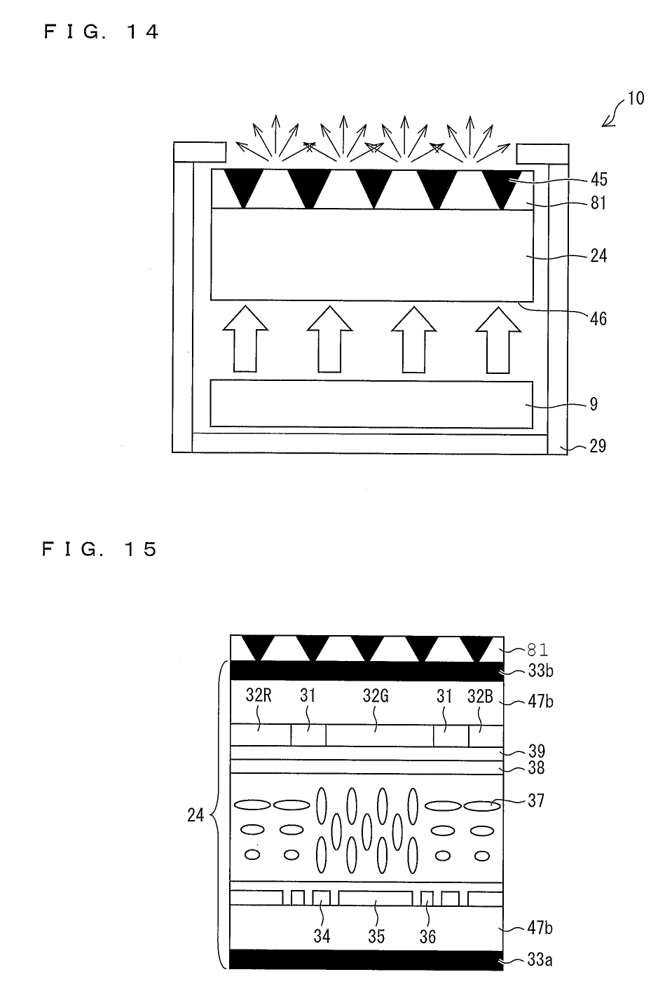

For example, a light-diffusion sheet in accordance with the present invention is applicable to a display device. The following description discusses a display device in accordance with the present invention with reference to FIGS. 14 and 15. FIG. 14 is a cross-sectional view schematically illustrating a display device 10 in accordance with an embodiment of the present invention. FIG. 15 is a cross-sectional view schematically illustrating a liquid crystal panel 24 and a light-diffusion sheet 81 which constitute the display device 10 in accordance with the embodiment of the present invention. Note that in FIG. 14, a reference number 9 indicates a backlight and a reference number 29 indicates a housing.

The display device 10 in accordance with the embodiment of the present invention is schematically arranged to include the liquid crystal panel 24, the light-diffusion sheet 81 which is provided on a display screen 45 of the liquid crystal panel 24, and the backlight 9 which is provided on a side of a surface 46 (hereinafter referred to as the other surface) of the liquid crystal panel 24 which surface is opposite from a surface on which the display screen 45 is provided (see FIG. 14).

The liquid crystal panel 24 includes a first polarizing plate 33a, a first wave plate (not illustrated), a first glass substrate 47a, a liquid crystal layer 37, color filters (32R, 32G, and 32B), a second glass substrate 47b, a second wave plate (not illustrated), and a second polarizing plate 33b which are stacked in this order (see FIG. 15). The light-diffusion sheet 81 is provided on the display screen 45 of the liquid crystal panel 24 via an adhesion layer (not illustrated).

A light-diffusion sheet which is similar to the light-diffusion sheet 1 of the First Embodiment is used as the light-diffusion sheet 81. Namely, the light-diffusion sheet 81 has a plurality of recessed parts each of which (i) has a wall surface that transmits or totally reflects entrance light having entered the light-diffusion sheet 81 from the other surface 46, (ii) opens in the surface that is opposite from the other surface 46, and (iii) includes a light blocking section.

A blind-like linear film called a louver may be provided between the liquid crystal panel 24 and the backlight 9. The blind-like linear film collimates light emitted from the backlight 9, so that the collimated light (parallel light) is directed to the liquid crystal panel 24. Alternatively, the blind-like linear film substantially collimates light emitted from the backlight 9, so that the substantially collimated light (substantially parallel light) is directed to the liquid crystal panel 24.

According to the display device 10 described above, the light-diffusion sheet 1 is provided on the display screen 45 of the liquid crystal panel 24. Therefore, the light-diffusion sheet 1 diffuses light which is emitted from the backlight 9 to the liquid crystal panel 24 and exits toward an observer (to the surface which is opposite from the other surface 46 of the light-diffusion sheet 1), so as to widen a viewing angle. Namely, the display device 10 allows obtainment of a wide viewing angle, has a high efficiency for light utilization, prevents occurrence of a stray light, and has a high visibility.

Note that the above description discusses a case where a light-diffusion sheet which is similar to the light-diffusion sheet 1 of the First Embodiment is used as the light-diffusion sheet 81. However, the display device 10 in accordance with the present invention is not limited to this. For example, each of the light-diffusion sheets 1a through 1d, 11, and 21 is usable as the light-diffusion sheet 81. According to the present invention, it is possible to use a light-diffusion sheet which is used in a display device such as a liquid crystal display device to widen a viewing angle of the display device.

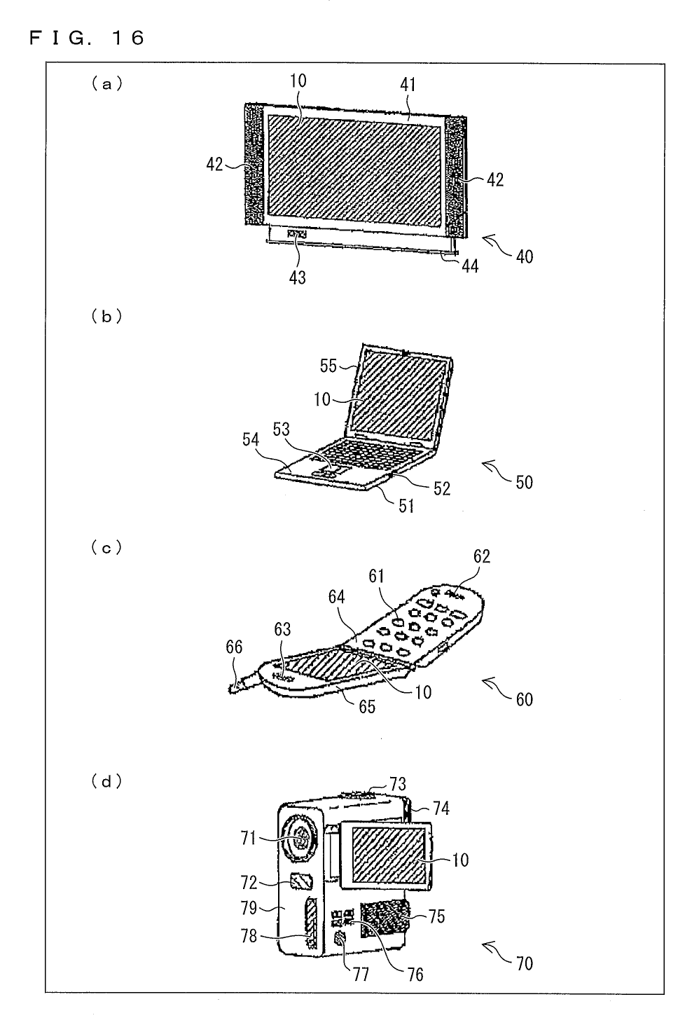

The display device 10 including a light-diffusion sheet in accordance with the present invention is applicable to various electronic devices. The following description discusses, with reference to FIG. 16, an electronic device including the display device 10 in accordance with the present invention. (a) of FIG. 16 is a perspective view illustrating an example of a television receiver 40 in accordance with an embodiment of the present invention. (b) of FIG. 16 is a perspective view illustrating an example of a personal computer 50 in accordance with an embodiment of the present invention. (c) of FIG. 16 is a perspective view illustrating an example of a mobile phone 60 in accordance with an embodiment of the present invention. (d) of FIG. 16 is a perspective view illustrating an example of a digital video camera 70 in accordance with an embodiment of the present invention.

The display device 10 in accordance with the present invention can be provided in the television receiver 40 (see (a) of FIG. 16). In (a) of FIG. 16, a reference number 41 indicates a housing, a reference number 42 indicates a speaker section, a reference number 43 indicates a video input terminal, and a reference number 44 indicates a supporting stand.

The display device 10 in accordance with the present invention can be provided in the personal computer 50 (see (b) of FIG. 16). In (b) of FIG. 16, a reference number 51 indicates a keyboard, a reference number 52 indicates an external connection port, a reference number 53 indicates a pointing mouse, a reference number 54 indicates a body, and a reference number 55 indicates a housing.

The display device 10 in accordance with the present invention can be provided in the mobile phone 60 (see (c) of FIG. 16). In (c) of FIG. 16, a reference number 61 indicates a operation key, a reference number 62 indicates a voice input section, a reference number 63 indicates a voice output section, a reference number 64 indicates a body, a reference number 65 indicates a housing, and a reference number 66 indicates an antenna.

The display device 10 in accordance with the present invention can be provided in the digital video camera 70 (see (d) of FIG. 16). In (d) of FIG. 16, a reference number 71 indicates an image receiving section, a reference number 72 indicates a remote control receiving section, a reference number 73 indicates a voice input section, a reference number 74 indicates an eyepiece section, a reference number 75 indicates a battery, each of reference numbers 76 and 77 indicates an operation key, a reference number 78 indicates an external connection port, and a reference number 79 indicates a body.

### Summary of Embodiments

As described earlier, the light-diffusion sheet in accordance with the present invention is arranged such that for the each of the plurality of recessed parts, the reflecting section is made of the mesoporous silica nanoparticle which is uncolored.

According to the arrangement, it is possible to prevent a reduction in efficiency for light utilization due to a contact of the light blocking section with the wall surface of the each of the plurality of recessed parts.

The light-diffusion sheet in accordance with the present invention is arranged such that for the each of the plurality of recessed parts, the reflecting section is made of the mesoporous silica nanoparticle which is uncolored.

According to the arrangement, the reflecting section is made of the mesoporous silica nanoparticle which is uncolored. This increases a difference in refractive index between the reflecting section and the light diffusing section, so that entrance light having entered the light-diffusion sheet can be totally reflected with great efficiency.

The light-diffusion sheet in accordance with the present invention is arranged such that for the each of the plurality of recessed parts, the light blocking section is made of the mesoporous silica nanoparticle whose top surface is coated with a black coloring matter.

According to the arrangement, the light blocking section is made of the mesoporous silica nanoparticle whose top surface is coated with a black coloring matter. According to this, the light blocking section absorbs light which is transmitted through the wall surface of the each of the plurality of recessed parts and enters the light blocking section. This can prevent occurrence of a stray light.

Further, merely covering the reflecting section 14 allows the light blocking section to sufficiently absorb light having entered the light blocking section. Accordingly, it is only necessary that the light blocking section be formed so as to cover the wall surface of the reflecting section. This allows a reduction in amount of use of the mesoporous silica nanoparticle whose top surface is coated with a black coloring matter. Therefore, a material cost of the light-diffusion sheet can be reduced and consequently a manufacturing cost can be reduced.

The light-diffusion sheet in accordance with the present invention is arranged such that: for the each of the plurality of recessed parts, the reflecting section is made of the mesoporous silica nanoparticle whose top surface is coated with a black coloring matter; and for the each of the plurality of recessed parts, the light blocking section is made of the mesoporous silica nanoparticle whose top surface is coated with the black coloring matter.

According to the arrangement, both the reflecting section and the light blocking section are made of the mesoporous silica nanoparticle whose top surface is coated with a black coloring matter. According to this, the mesoporous silica nanoparticle whose top surface is coated with a black coloring matter allows the reflecting section to have a low refractive index. Further, light having entered the light blocking section can thus be absorbed by the mesoporous silica nanoparticle whose top surface is coated with a black coloring matter. Namely, the mesoporous silica nanoparticle whose top surface is coated with a black coloring matter can serve as both the light blocking section and the reflecting section. This allows a reduction in material for use in the light-diffusion sheet and consequently allows a reduction in cost of manufacturing the light-diffusion sheet.

The light-diffusion sheet in accordance with the present invention is arranged such that for the each of the plurality of recessed parts, the light blocking section is provided so as to reach a vicinity of the deepest part of the each of the plurality of recessed parts.

According to the arrangement, light such as a stray light having entered the vicinity of the deepest part of the each of the plurality of recessed parts of the light diffusing section can be substantially securely absorbed.

The light-diffusion sheet in accordance with the present invention is arranged such that the each of the plurality of recessed parts has a cross section which narrows toward the light entrance surface and is substantially v-shaped, the cross section having been obtained by cutting the light diffusing section in a thickness direction of the light diffusing section.

The light-diffusion sheet in accordance with the present invention is arranged such that the each of the plurality of recessed parts has a substantially conical or pyramidal shape which narrows toward the light entrance surface.

The arrangement allows diffusion of entrance light in vertical and horizontal directions, allows a single light-diffusion sheet to diffuse light with great efficiency, so that a wide viewing angle can be obtained.

The light-diffusion sheet in accordance with the present invention is arranged such that the black coloring matter is carbon black.

The light-diffusion sheet in accordance with the present invention is arranged such that the black coloring matter is an azine compound.

According to the arrangement, light can be absorbed with great efficiency in a case where the top surface of the mesoporous silica nanoparticle is coated with the black coloring matter.

The light-diffusion sheet in accordance with the present invention is arranged such that the plurality of recessed parts are periodically provided in a one-dimensional direction in the light exit surface.

The light-diffusion sheet in accordance with the present invention is arranged such that the plurality of recessed parts are periodically provided in a one-dimensional direction in the light exit surface.

The arrangement allows diffusion of entrance light in vertical and horizontal directions, allows a single light-diffusion sheet to diffuse light with great efficiency, so that a wide viewing angle can be obtained.

The light-diffusion sheet in accordance with the present invention is arranged such that the plurality of recessed parts are non-periodically provided in a two-dimensional direction in the light exit surface.

The light-diffusion sheet in accordance with the present invention is arranged such that the plurality of recessed parts are non-periodically provided in a two-dimensional direction in the light exit surface.

According to the arrangement, the plurality of recessed parts are randomly provided. This can prevent a moire which occurs between the light-diffusion sheet and a periodic structure which is existing in a display device to which the light-diffusion sheet is applied. Further, light which is transmitted through the light-diffusion sheet can prevent interference which is caused by a structure such as the plurality of recessed parts which are periodically provided.

The method in accordance with the present invention for manufacturing a light-diffusion sheet is arranged such that in the step (b), for the each of the plurality of light blocking sections, the reflecting section is made of the mesoporous silica nanoparticle which is uncolored.

The method in accordance with the present invention for manufacturing a light-diffusion sheet is arranged such that in the step (a), the plurality of light blocking sections are made of the mesoporous silica nanoparticle whose top surface is coated with a black coloring matter.

The method in accordance with the present invention for manufacturing a light-diffusion sheet is arranged such that: in the step (a), the plurality of light blocking sections are made of the mesoporous silica nanoparticle whose top surface is coated with a black coloring matter; and in the step (b), for the each of the plurality of light blocking sections, the reflecting section is made of the mesoporous silica nanoparticle whose top surface is coated with the black coloring matter.

According to the method, it is possible to provide a light-diffusion sheet which prevents a decrease in front contrast and occurrence of a blur in an image and allows obtainment of a high visibility.

The embodiments and concrete examples of implementation discussed in the aforementioned detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention can be used for a light-diffusion sheet which is used in a display device such as a liquid crystal display device to increase a viewing angle of the display device.

### REFERENCE SIGNS LIST

1, 1a-1d, 11, 21 Light-diffusion Sheet

2, 12, 22 Light Diffusing Section

3, 13 Light Blocking Section

4, 14 Reflecting Section

5, 15, 25 Recessed Part

6, 16, 26 Substrate

7, 17 Light Blocking Section Formation Mold

8, 18, 28 Mesoporous Silica

19 Black Coloring Matter

20, 30 Black Mesoporous Silica

23 Low Refractive Index Light Blocking Section

27 Low Refractive Index Light Blocking Section Formation Mold

1. A light-diffusion sheet comprising:
a light diffusing section which diffuses entrance light having entered the light-diffusion sheet through a light entrance surface thereof and causes the diffused entrance light to exit from the light-diffusion sheet through a light exit surface thereof;
a supporting film which is provided on the light exit surface of the light diffusing section;
a plurality of recessed parts which are provided in the light diffusing section on the light exit surface side and each of which has a wall surface that transmits or totally reflects the entrance light;
a reflecting section which is provided in at least a part of the wall surface of each of the plurality of recessed parts and is made of a mesoporous silica nanoparticle, the reflecting section being provided for the each of the plurality of recessed parts; and
a light blocking section which (i) is provided in a space defined by the reflecting section in a space defined by the wall surface and (ii) is supported by the supporting film, the light blocking section being provided for the each of the plurality of recessed parts.

2. The light-diffusion sheet as set forth in claim 1, wherein for the each of the plurality of recessed parts, the reflecting section is provided so as to entirely cover the wall surface of the each of the plurality of recessed parts.

3. The light-diffusion sheet as set forth in claim 1, wherein for the each of the plurality of recessed parts, the reflecting section is made of the mesoporous silica nanoparticle which is uncolored.

4. The light-diffusion sheet as set forth in claim 3, wherein for the each of the plurality of recessed parts, the light blocking section is made of the mesoporous silica nanoparticle whose top surface is coated with a black coloring matter.

5. The light-diffusion sheet as set forth in claim 1, wherein:
for the each of the plurality of recessed parts, the reflecting section is made of the mesoporous silica nanoparticle whose top surface is coated with a black coloring matter; and
for the each of the plurality of recessed parts, the light blocking section is made of the mesoporous silica nanoparticle whose top surface is coated with the black coloring matter.

6. The light-diffusion sheet as set forth in claim 3, wherein for the each of the plurality of recessed parts, the light blocking section is provided so as to reach a vicinity of the deepest part of the each of the plurality of recessed parts.

7. The light-diffusion sheet as set forth in claim 1, wherein the each of the plurality of recessed parts has a cross section which narrows toward the light entrance surface and is substantially v-shaped, the cross section having been obtained by cutting the light diffusing section in a thickness direction of the light diffusing section.

8. The light-diffusion sheet as set forth in claim 7, wherein the each of the plurality of recessed parts has a substantially conical or pyramidal shape which narrows toward the light entrance surface.

9. The light-diffusion sheet as set forth in claim 4, wherein the black coloring matter is carbon black.

10. The light-diffusion sheet as set forth in claim 4, wherein the black coloring matter is an azine compound.

11. The light-diffusion sheet as set forth in claim 1, wherein the plurality of recessed parts are periodically provided in a one-dimensional direction in the light exit surface.

12. The light-diffusion sheet as set forth in claim 1, wherein the plurality of recessed parts are non-periodically provided in a one-dimensional direction in the light exit surface.

13. The light-diffusion sheet as set forth in claim 7, wherein the plurality of recessed parts are periodically provided in a two-dimensional direction in the light exit surface.

14. The light-diffusion sheet as set forth in claim 7, wherein the plurality of recessed parts are non-periodically provided in a two-dimensional direction in the light exit surface.

15. A transmission display device comprising a light-diffusion sheet recited in claim 1.

16. A method for manufacturing a light-diffusion sheet including a light diffusing section which diffuses entrance light having entered the light-diffusion sheet through a light entrance surface thereof and causes the diffused entrance light to exit from the light-diffusion sheet through a light exit surface thereof,
said method comprising the steps of:
(a) forming a plurality of light blocking sections on a supporting film;
(b) for each of the plurality of light blocking sections, forming a reflecting section by applying a mesoporous silica nanoparticle to at least a part of a top surface of the each of the plurality of light blocking sections; and
(c) after the step (b), forming the light diffusing section so that the light diffusing section covers a top surface of the reflecting section, the light diffusing section being provided on a side of the supporting film on which side the plurality of light blocking sections are provided.

17. The method as set forth in claim 16, wherein in the step (b), for the each of the plurality of light blocking sections, the reflecting section is made of the mesoporous silica nanoparticle which is uncolored.

18. The method as set forth in claim 17, wherein in the step (a), the plurality of light blocking sections are made of the mesoporous silica nanoparticle whose top surface is coated with a black coloring matter.

19. The method as set forth in claim 16, wherein:
in the step (a), the plurality of light blocking sections are made of the mesoporous silica nanoparticle whose top surface is coated with a black coloring matter; and
in the step (b), for the each of the plurality of light blocking sections, the reflecting section is made of the mesoporous silica nanoparticle whose top surface is coated with the black coloring matter.
